(19) United States
(12) Patent Application Publication
(10) Pub. No.: US 2008/0200999 A1
(43) Pub. Date: Aug. 21, 2008

(54) PLAYER DEVICE CONTROLLABLE BY FUNCTIONAL META-DATA, CONTENT ITEM COMPRISING SUCH META-DATA, AND COMPUTER PROGRAM PRODUCT THEREFOR

(76) Inventor: Johannes HAKANSSON, Eslov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/675,305

(22) Filed: Feb. 15, 2007

(51) Int. Cl. G06F 17/00; H04N 7/10

(52) U.S. Cl. 700/94; 725/32

(57) ABSTRACT

The invention relates to a player device (1) controllable by functional meta-data (9), and particularly devised to receive meta-data containing an object (10) used to add, adapt or control features of the device. The player device comprises: a decoder means (3) for extracting meta-data (9) from a data file (2) further containing payload data (8); a control unit (4); a user interface (5) comprising presentation means and input means. The decoder means is adapted to extract an object (10) from the meta-data, the object containing a feature for use in the user interface and to forward the payload data to the user interface, and the control unit is adapted to control the user interface in dependence of the object. The invention also relates to a content item containing such an object and a computer program product for providing a user interface controllable by meta-data in a player device.

### FIELD OF THE INVENTION

The present invention relates to a player device controllable by functional meta-data, and particularly devised to receive meta-data containing an object used to add, adapt or control features of the device. The invention also relates to a content item containing such an object and a computer program product for providing a user interface controllable by meta-data in a player device.

### BACKGROUND OF THE INVENTION

Player devices, such as those incorporated in mobile telephones, often contain audio/video players for playing back music and video. The audio/video data is retrieved and/or stored as binary files, which may contain meta-data. The meta-data is data additional to payload data which contains the audio/video data proper. The data may be stored in various formats, such as MP3, WMA, AAC or Ogg Vorbis. A special format for meta-data is ID3 tags. The meta-data may describe the content of the file, including song title, artist, album, year, comment, track and genre. It may also contain fields or frames for any kind of data. The tags are used for searching as well as displaying the title being played.

The U.S. published patent application US 2004/0029525 discloses a tuning engine and user interface for Internet broadcast on mobile devices. In one embodiment the disclosed system sorts out audio broadcast of interest by organizing and categorizing audio content area via the tuning engine. The tuning engine comprises a program filter/classifier, which may extract meta-data and/or meta-tags from a web page. The system further exploits a relational database in which the user has entered a description of his preferences.

The U.S. published patent application US 2005/0102308 discloses a system for adaptively interfacing with a data repository having associated meta-data. The user interface is dynamically generated having interface elements that are dependent upon the meta-data.

The object of the present invention is to provide a device with enhanced possibilities to exploit meta-data, and particularly to automatically control a user interface through objects extracted from meta-data.

A further object of the invention is to provide a content item with an object encapsulated in meta-data. The object contains a feature for use in a user interface. Particularly the object contains a feature having an association with the contents of the payload data.

A still further object of the invention is to provide a computer program product for providing a user interface controllable by meta-data in a player device.

### SUMMARY OF THE INVENTION

In a first aspect, the invention provides a player device comprising: a decoder means for extracting meta-data from a data file further containing

payload data;
a control unit;
a user interface comprising presentation means and input means.

The decoder means is adapted to extract an object from the meta-data, the object containing a feature for use in the user interface and to forward the payload data to the user interface, and

the control unit is adapted to control the user interface in dependence of the object.

Preferably, the decoder is adapted to control the authenticity and/or integrity of the object.

In one embodiment, the decoder is adapted to extract validity information from the object, and the control unit is adapted to process the object in dependence of the validity information.

The object may contain an image, and the control unit may be adapted to use the image in the user interface.

In one embodiment, the control unit is adapted to use the image in the presentation means in connection with using the payload data of the file from which the object emanated.

The object may contain an application, and the control unit may be adapted to run the application in connection with controlling the user interface.

The application may contain a player symbol, a menu item, and/or background images.

The application may contain data to present a message to a user.

The application may further contain data to let the user interact with the player device through the input means.

The application may further contains an offer to buy a commodity.

In one embodiment, the application contains address data, and the device further contains a communication interface controlled by the control unit, and the control unit is adapted to establish communication with an entity defined by the address data through the communication interface.

In one embodiment, the object contains a version label, and the control unit is adapted to control software in the device against the version label for compatibility.

The player may be a portable music player device, such as a dedicated music player, an electronic device additionally containing a music player, a mobile telephone, a pager, a communicator, a smart phone or an electronic organizer.

In a second aspect, the invention provides a content item comprising meta-data and payload data, wherein an object is encapsulated in the meta-data, the object containing a feature for use in a user interface of a player device.

Preferably, the object is protected by a key enabling an authenticity check.

The object may contain an image for use in the user interface.

The object may contain an application, to be executed in connection with controlling the user interface.

The application may contain a player symbol, a menu item, and/or background images.

The application may contain data to present a message to a user.

The application may further contain data to let the user interact with the player device through the input means.

The application may further contain an offer to buy a commodity.

The application may contain address data for establishing communication with an entity defined by the address data.

The object may contain a version label for controlling software in a device against the version label for compatibility.

In a third aspect, the invention provides a computer program product for providing a user interface controllable by meta-data in a player device, said computer program product comprising:

computer program code means for providing a decoder means for extracting meta-data from a data file further containing payload data, such that the decoder means is adapted to extract an object from the meta-data, the object containing a feature for use in the user interface and to forward the payload data to the user interface, and such that the user interface is controllable in dependence of the object.

The object may contain features as outlined above.

### BRIEF DESCRIPTION OF THE DRAWINGS

Embodiments of the invention will be described in detail below with reference to the accompanying drawings, in which:

FIG. 1 is a schematic diagram of a player according to an embodiment of the invention, and

FIG. 2 is a schematic diagram of a display screen of a player device according to the invention.

### DETAILED DESCRIPTION OF PREFERRED EMBODIMENTS

The invention will be described with reference to a portable music player device, such as a dedicated music player, an electronic device additionally containing a music player, e.g. a mobile telephone, a pager, a communicator, a smart phone or an electronic organizer. The invention is equally applicable in general multimedia players and stationary devices, such as video systems, sound systems and stationary computers.

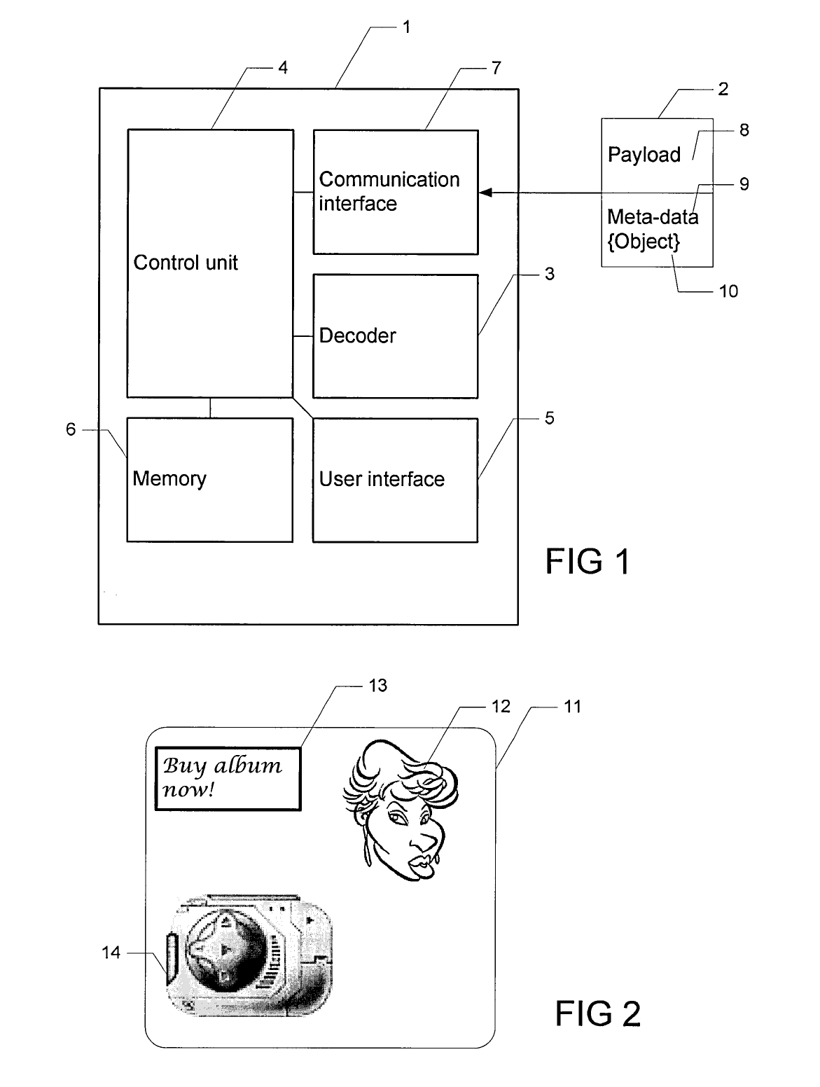

A schematic illustration of an embodiment of a music player according to the invention is shown in FIG. 1. The player device 1 is capable of playing sound from a data file 2. The data file 2 may be a so-called content item bought from a content provider. Generally, the file may be a multimedia file that contains graphics, animation, audio or video data. The data file 2 may reside in a memory 6 incorporated in, or connected to, the device 1, or be streamed down via a communication interface 7 and partially stored in a buffer memory, e.g. in memory 6.

As is mentioned previously, various formats for sound data exist today. They comprise payload data 8, which is the actual data to be played back by the device 1, and meta-data 9. The meta-data may reside as a header or at the end of the data file. In case of the ID3 format, the ID3 tag comprises e.g. a text field, a date field and a genre field, etc. The tag may also comprise a general encapsulated object, i.e. an object of any type that is just contained in the meta-data 9, which may be used or not, depending on the device receiving the data file 2.

The player device 1 comprises a control unit 4 controlling the operation of the device 1 by means of hardware and software. A user interface 5 comprises a reproduction system with a visual display and loudspeakers as well as control buttons, a keypad or other knobs, for letting the user inputting commands to the player device 1. The player device 1 further comprises a decoder 3 for extracting the meta-data 9 and forwarding the payload 8 to the user interface 5. The decoder 3 is adapted to extract and parse data of the encapsulated object 10. Preferably, the decoder 3 is adapted to control the authenticity and integrity of the object 10. The object 10 may be protected with keys, which may be used to perform an authenticity check. Also, an integrity check may be performed for error correction using conventional methods.

The object 10 may also contain validity data, i.e. the object 10 contains information about times and dates when the object is valid. For example, after a specified date the object is no longer valid and is ignored and/or deleted from the device 1.

The object 10 may be packaged to contain various types of data, such as images, audio/video data, applications, i.e. executable software such as widgets, Midlets (Java application) and plug-ins, etc. The object is packaged and encapsulated in such a way that if a player device, not fitted with the present invention, receives such a data file, the object 10 is simply ignored and does not disturb any other functions of the device. Generally, there is no limit of the size of the object 10, and it may even be larger than the payload 8 and the rest of the meta-data 9. On the other hand, size costs and today it is expected that the size of the object is within the range of 1 kbyte and 5 Mbyte. This should be compared to typical audio file sizes of 3 to 7 Mbyte.

### EXAMPLES

FIG. 2 shows a display screen 11, forming part of the user interface 5 of the player 1 according to embodiments of the invention.

In this example, the player device 1 is a mobile telephone with a music player incorporated. A music data file 2 originating from some content provider is downloaded through the communication interface 7 and stored in the memory 6. Alternatively, the data file 2 is previously stored on an external memory, inserted and connected to the device 1. The content of the object is decided by the entity inserting the object in the data file 2, typically a content provider which may be contacted by means of the communications interface 7.

When the data file 2 is to be used, the control unit 4 commands the decoder 3 to extract and process the meta-data 9. The object 10 may for example contain an image 12 of the artist performing the music. Thus, when the user plays the audio file, the image 12 is shown on the display screen 11. In this way a content provider may insert an image associated with the particular musical content directly in the data file 2.

The object 10 may also contain video information such that moving images are shown on the display screen 11.

The object 10 may also contain a skin, i.e. a special look of a graphical user interface such as a player symbol shown at 14. When the user plays an audio file the look of the player symbol 14 is changed in dependence of the object 10, which may be associated with the particular musical content of the payload 8, as decided by the content provider.

The object 10 may also contain mini applications, containing menu items, pop-up messages, adverts, animations, themes etc. For example a pop-up message, such as shown at 13, may be shown on the display screen 11 when the user plays the data file 2. The application contained in the object 10 is run when the data file 2 is played back. The pop-up message 13 is shown letting the user interact with the message using the user interface 5. For example the pop-up message may contain a link (a url or other address data) to content provider, such that the user may access content providers by following the links shown in the message 13 in a very simple way.

The object 10 may further contain information about final validity date, in which case the pop-up message may contain a time limited offer. When the time has expired, the application contained in the object 10 will be ignored and/or deleted such that the message 13 is not shown after the final validity date.

The pop-up message may contain various offers to buy commodities, such as tickets to concerts. Thus, the content provider may customize offers and associate an offer with music sold as data files and associate the offer with current events like concerts.

To ensure that the application contained in an object 10 functions properly, the object 10 may further contain version labels such as “This audio file/application operates with player version 2.5 or later” or similar.

Generally, an object 10 is inserted by a content provider, who has full control over the object and with which players 1 the object is intended to function. On the other hand, the user of the player device 1 does not have to take any action to benefit from the invention, as long as it is implemented in the player device 1.

The content provider may allow the object to be used independently of the data file from which it emanated. A validity field in the meta-data may be used to define if the object is allowed to be saved separately or only allowed to be rendered by the file. For example, if allowed, an image or skin may be stored by the user in the memory 6 or elsewhere for use at any time.

The invention may be implemented in the player device 1 by programming. In an embodiment of the invention, a computer program product comprises computer program code means, which is loaded into the player device such that a decoder 3, having the capability of the invention as described above, is created. The computer program product may e.g. be a data file downloadable through the communications interface 7, or inserted in the device by means of an external memory or other storage and transmission media.

The invention may be implemented by means of suitable combinations of hardware and software. The invention is not limited to any particular format of multimedia data and meta-data, though the examples cited above are suitable. Further formats may be developed in the future providing the same technical functions. The scope of the invention is only limited by the claims below.

1. A player device comprising:
a decoder means for extracting meta-data from a data file further containing
payload data;
a control unit;
a user interface comprising presentation means and input means, wherein the decoder means is adapted to extract an object from the meta-data, the object containing a feature for use in the user interface and to forward the payload data to the user interface, and
wherein the control unit is adapted to control the user interface in dependence of the object.

2. A player device in accordance with claim 1, wherein the decoder is adapted to control the authenticity and/or integrity of the object.

3. A player device in accordance with claim 1, wherein the decoder is adapted to extract validity information from the object, and the control unit is adapted to process the object in dependence of the validity information.

4. A player device in accordance with claim 1, wherein the object contains an image, and the control unit is adapted to use the image in the user interface.

5. A player device in accordance with claim 4, wherein the control unit is adapted to use the image in the presentation means in connection with using the payload data of the file from which the object emanated.

6. A player device in accordance with claim 1, wherein the object contains an application, and the control unit is adapted to run the application in connection with controlling the user interface.

7. A player device in accordance with claim 6, wherein the application contains a player symbol, a menu item, and/or background images.

8. A player device in accordance with claim 6, wherein the application contains data to present a message to a user.

9. A player device in accordance with claim 8, wherein the application further contains data to let the user interact with the player device through the input means.

10. A player device in accordance with claim 9, wherein the application further contains an offer to buy a commodity.

11. A player device in accordance with claim 6, wherein the application contains address data, and the device further contains a communication interface controlled by the control unit, and wherein the control unit is adapted to establish communication with an entity defined by the address data through the communication interface.

12. A player device in accordance with claim 6, wherein the object contains a version label, and the control unit is adapted to control software in the device against the version label for compatibility.

13. A player device in accordance with claim 1, wherein player is a portable music player device, such as a dedicated music player, an electronic device additionally containing a music player, a mobile telephone, a pager, a communicator, a smart phone or an electronic organizer.

14. A content item comprising meta-data and payload data, wherein an object is encapsulated in the meta-data, the object containing a feature for use in a user interface of a player device.

15. A content item in accordance with claim 14, wherein the object is protected by a key enabling an authenticity check.

16. A content item in accordance with claim 14, wherein the object contains an image for use in the user interface.

17. A content item in accordance with claim 14, wherein the object contains an application, to be executed in connection with controlling the user interface.

18. A content item in accordance with claim 17, wherein the application contains a player symbol, a menu item, and/or background images.

19. A content item in accordance with claim 14, wherein the application contains data to present a message to a user.

20. A content item in accordance with claim 19, wherein the application further contains data to let the user interact with the player device through the input means.

21. A content item in accordance with claim 20, wherein the application further contains an offer to buy a commodity.

22. A content item in accordance with claim 14, wherein the application contains address data for establishing communication with an entity defined by the address data.

23. A content item in accordance with claim 14, wherein the object contains a version label for controlling software in a device against the version label for compatibility.

24. A computer program product for providing a user interface controllable by meta-data in a player device, said computer program product comprising:
computer program code means for providing a decoder means for extracting meta-data from a data file further containing payload data, such that the decoder means is adapted to extract an object from the meta-data, the object containing a feature for use in the user interface and to forward the payload data to the user interface, and such that the user interface is controllable in dependence of the object.
